(19) United States
(12) Patent Application Publication
(10) Pub. No.: US 2009/0271410 A1
(43) Pub. Date: Oct. 29, 2009

(54) System and a Method for Handling Co-Operation Files

(75) Inventors: Per Buus Sorensen, Aalborg (DK); Nis Holdt, Ebeltoft (DK)

Correspondence Address: DAY PITNEY LLP, 7 TIMES SQUARE, NEW YORK, NY, 10036-7311, US

(73) Assignee: MEDIA4WORK APS, Randers (DK)

(21) Appl. No.: 12/086,044

(22) PCT Filed: Nov. 28, 2006
(86) PCT No.: PCT/DK2006/000663

§ 371 Date: Jul. 29, 2008

(30) Foreign Application Priority Data
Dec. 6, 2005 (DK) PA 2005 01730

(51) Int. Cl. G06F 17/30; G06F 12/00

(52) U.S. Cl. 707/10; 707/203; 707/E17.01; 707/E17.032

(57) ABSTRACT

The invention relates to a method for handling co-operation files, where the content of the co-operation files is of the type that describes the co-operation basis in relation to a co-operation between customers and suppliers, and where a unique ID is attached to a co-operation file, where the customer stores co-operation files on a central file handling database and where the co-operation files of the supplier are stored on a supplier computer, the method comprising:
checking if a co-operation file exists on the central database with an ID matching the ID of the co-operation file stored on the supplier's storage medium where the checking is initiated by the supplier trying to access the co-operation file stored on the supplier's storage medium,
informing the user of the supplier's computer if a version of the co-operation file stored on the central file server differs from the version of the co-operation file stored on the supplier's storage medium.

The present invention regards a system and a method for handling co-operation files, where the co-operation files are files that represent the co-operation basis for co-operation between customers and suppliers.

### BACKGROUND

When a co-operation between customers and their suppliers and sub suppliers exists, a co-operation file has been devised as a basis for this cooperation—e.g. printing instructions, drawings or production instructions describing how items are to be used and/or manufactured. The co-operation file is usually transferred to the supplier in electronic form and the item of the supplier is then manufactured on basis of this electronic production bases, also designated a co-operation file, that describes the co-operation basis relating to the co-operation between the customer and the supplier.

One problem in this regard is that many companies that use suppliers are charged for the devising of the electronic co-operation file for the product, which the company buys from the supplier, even though the electronic co-operation file has already been devised and thus already exists. This of course increases costs for the buying company.

Another problem occurs in that many companies that use suppliers and sub-suppliers send new versions of their electronic co-operation file, or send a message that a new version exists, to their suppliers. However, the companies may not be aware that their supplier uses sub suppliers and therefore the sub supplier may not receive the new information, or the suppliers and sub-suppliers receive the information much before they are to use them and thus need to manage the information from the time they receive it and until they are to use it.

A further problem is that suppliers or sub suppliers would often use an existing electronic co-operation file already held by the supplier. This has the effect that the product delivered to the company is manufactured on the basis of an outdated electronic co-operation file, which again means that the product needs to be re-manufactured on the basis of the correct co-operation file—again resulting in delays and increased costs.

Another problem occurs in that the company often does not know the actual supplier as this supplier is a supplier to the supplier. The supplier, and more decisively the sub supplier, often has problems finding the electronic co-operation file for the product, even though the customer has made the file public. The supplier and the sub supplier then often tend to use the first co-operation file that comes in hand which is very often defective, thus resulting in items that are not uniform among suppliers.

Another problem arises when a company uses more suppliers that are all using the same sub suppliers. When a company wishes to change supplier, the company may not change sub supplier. However, the company does not know whether this is the case or not. This results in the company asking its supplier to provide the electronic co-operation file. The sub supplier provides the supplier with the co-operation file and the supplier delivers it to the company. The company then sends the co-operation file to its new supplier which then sends it to the original sub supplier with big costs as a result.

Another problem in relation to co-operation files is that companies do not want to open their electronic co-operation file to the public. It is therefore in the interest of the company to be able to control who gets access to the electronic co-operation file and take measures to prevent unintentional access to other sources of electronic information.

WO 01/67279 describes a system and a method for building a database for the design and execution of projects. The system is used when working on a project by a number of project members; the project members are defined on a central database and each time a project file is amended, the project members receive a message. Problems with this system is that only predefined project members are informed about the updates, and therefore any other party accessing project files will not know about any updates. Further, because the system transmits updates each time a project file is updated, all project members receive a lot of messages, which could be irrelevant to some members and where the large amount of messages further affects the performance of the system.

### OBJECT AND DESCRIPTION OF THE INVENTION

It is the object of the invention to provide a solution to the above-mentioned problems.

This can be done by a method for handling co-operation files, where the content of the co-operation files is of the type that describes the co-operation basis in relation to a co-operation between customers and suppliers, and where a unique ID is attached to a co-operation file, where the customer stores co-operation files on a central file handling database and where the co-operation files of the supplier are stored on a supplier computer, the method comprising:
checking if a co-operation file exists on the central database with an ID matching the ID of the co-operation file stored on the supplier's storage medium where the checking is initiated by the supplier trying to access the co-operation file stored on the supplier's storage medium,
informing the user of the supplier's computer if a version of the co-operation file stored on the central file server differs from the version of the co-operation file stored on the supplier's storage medium.

This will ensure that suppliers and sub suppliers always use the correct version of the co-operation file. Further, suppliers and sub suppliers do no longer have to control whether they are in possession of the newest version of a co-operation file. Further, the customer does not have to keep track of who the supplier or sub supplier is, or if new suppliers or sub suppliers are involved, as long as they have delivered other items to the customer before, as in this case the supplier or sub supplier would know where to retrieve the co-operation file. In other words, the supplier and sub supplier only have to be informed once that the company uses a file handling database, and it is ensured that suppliers and sub suppliers use a uniform co-operation file. A further advantage is that only when the user is trying to access a locally stored co-operation file, the version checking is performed, and the user is informed if the locally stored version is the newest version.

A co-operation file might be a logo design, measurements, architect drawings, printing designs, diagrams and other documents used as the basis of a co-operation between suppliers and their customers.

A unique ID is something that identifies a co-operation file so that the co-operation file can be distinguished from other co-operation files. Examples of ID could be a hash value, the name of the file, a unique value associated with the file and so on.

A further advantage is that suppliers and sub suppliers are notified if a newer version of the electronic co-operation file exists or is under construction. Further, this means that suppliers and sub suppliers have to retrieve the co-operation file from one place only no matter to which company the product is manufactured. The final product manufactured for the client will therefore be uniform, no matter where in the world it is manufactured.

A further advantage is that companies that wish to give their suppliers and sub suppliers access to their co-operation files do not necessarily make information from their core business vulnerable to unauthorized use and is placed with a third party where the central file handling database of the third party is secured against unauthorized use.

A further advantage is that the customer does not have to send the electronic co-operation file to all suppliers and sub suppliers. The customer only needs to upload the new version to the central file server. New suppliers only need to know that the co-operation files are on the central file server. When a sub supplier is contacted, this sub supplier is already in possession of the concerned correct co-operation file.

In a specific embodiment of the invention the message to the supplier's computer comprises transfer of the co-operation file with the newer version number to the supplier's computer. Hereby it is ensured that the supplier can only access the newest version and that this version is locally accessible without the supplier having to take further action.

In a specific embodiment of the invention the comparison of the version number further comprises an investigation as to whether a new co-operation file is under construction through a construction identification attached to the file and stored on the central database, and if this is the case a message is sent to the supplier's computer. In this way the supplier is made aware, simply and quickly, that the version that is accessed is being changed and thus a lot of unnecessary work is avoided. The supplier might choose to postpone his work until the co-operation basis is completed.

The invention further relates to a computer readable medium having stored therein instructions that will make a processing unit perform the method as described above.

The invention further relates to a co-operation file of the type which describes the co-operation basis in relation to a co-operation between customers and suppliers and where a unique ID and a version number are associated with the co-operation file, where the co-operation file is adapted to be used in a method a described above.

In an embodiment the co-operation file is associated with an identification of the person having created the file. Hereby it is possible for the person accessing the file to identify the person having created the file and to get in contact with this person if there are any questions concerning the amendments.

The invention also covers a system for handling co-operation files where the content of the co-operation files is of the type that describes the co-operation basis in relation to a co-operation between customers and suppliers, and where a unique ID is associated with a co-operation file, where the customer stores co-operation files on a central file handling database and where the co-operation files of the supplier are stored on a supplier computer, the system comprising:
a processor adapted to check if a co-operation file exists on the central database with an ID matching the ID of the co-operation file stored on the supplier's storage medium where the check is initiated by the supplier trying to access the co-operation file stored on the supplier's storage medium,
a processor adapted to inform the user of the supplier's computer if a version of the co-operation file stored on the central file server differs from the version of the co-operation file stored on the supplier's storage medium.

### BRIEF DESCRIPTION OF THE DRAWINGS

In the following the invention will be described in details referring to the drawing on which:

FIG. 1 shows a system for handling co-operation files,

FIG. 2 shows a diagram of a method for handling co-operation files,

FIG. 3 shows a flow diagram for the functionality of the system, when a supplier wished to access a co-operation file,

FIG. 4 shows a flow diagram for the functionality of the system, when a customer wishes to change the co-operation file,

FIG. 5 shows a flow diagram illustrating the interaction between the supplier's computer and the central file server,

FIG. 6 shows a more detailed flow diagram illustrating, by way of example, the interaction between the supplier's computer and the central file server.

### DETAILED DESCRIPTION OF EMBODIMENTS OF THE PRESENT INVENTION

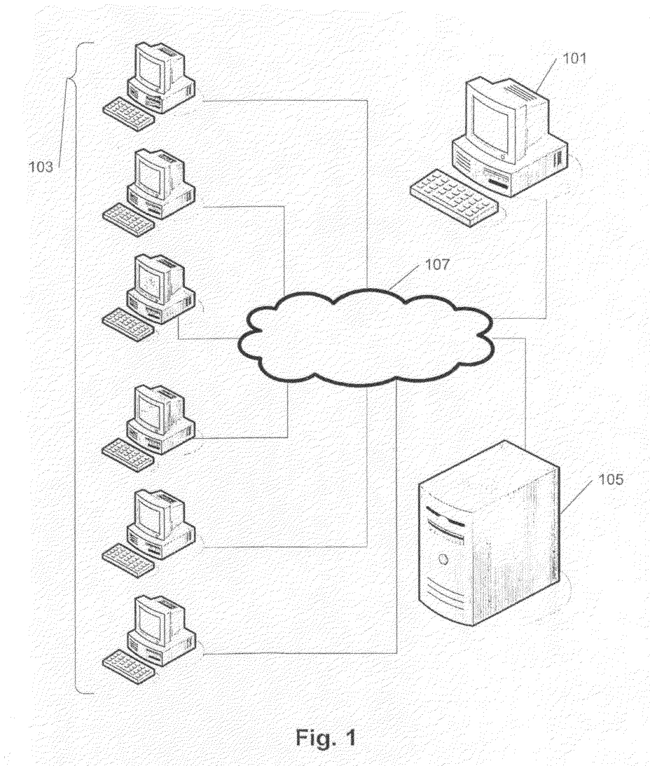

FIG. 1 shows a system for handling co-operation files where the system comprises a customer computer 101, a number of supplier computers 103 and a central file server 105. All computers are linked together by a network, for example the internet 107.

The file server, which can be accessed from a customer computer or a supplier computer via the internet, stores all co-operation files for all customers that are using the system. When a co-operation file has been created, the customer copies the co-operation file from the customer computer 101 to the file server 105 and hereafter all suppliers and sub suppliers can retrieve the co-operation file from this server via a supplier computer 103.

The co-operation with the suppliers consists of the customer ordering an item from a supplier; in this connection the customer also sends the unique identification of the co-operation file—e.g. the product specification—to the supplier. If the supplier uses a sub supplier, the sub supplier is given the identification of the co-operation file from the supplier. With the unique identification of the co-operation file, the sub supplier can copy the co-operation file from the file server 105.

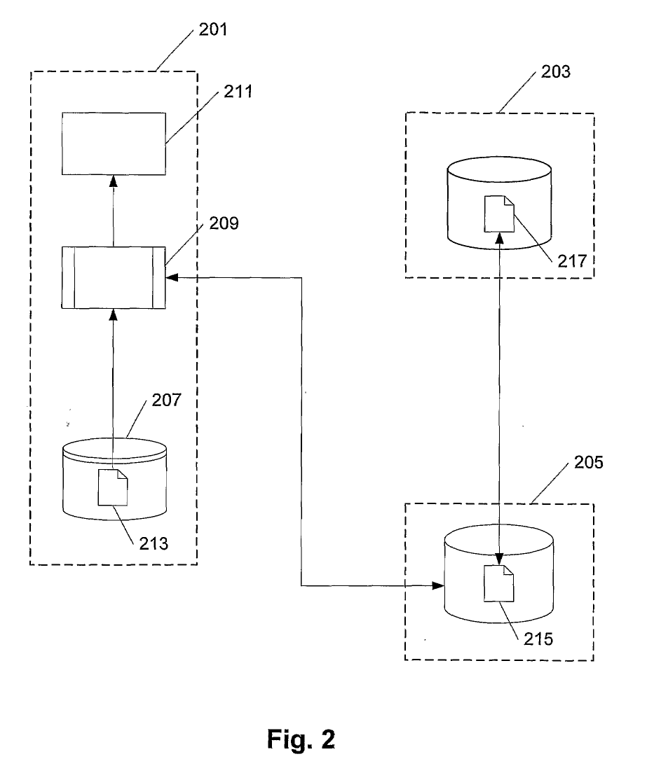

FIG. 2 shows a diagram of the method for handling co-operation files. A supplier or sub supplier is to start working on an item described in a co-operation file 213 stored on the supplier computer's 201 storage medium 207. Before the supplier gets access to the co-operation file 213, it is checked in 209 if a newer version of the file exists on the file server 205. This can be done in that the co-operation file has a unique ID and where the co-operation file attached to the ID is compared to the version of a co-operation file with an identical ID on the file server 205.

If it is the first time that the supplier is to use the co-operation file 215, the supplier is told to copy the file from the file server 205. If the supplier has already copied the co-operation file, it is checked if a newer version exists on the file server. If this is the case, the supplier is told to copy the newest version of the co-operation file 215 from the central file server 205. If this is not the case, the supplier is told that he/she can use the co-operation file 213 already held by the supplier.

More specifically, the investigation in 209 can be done by a piece of software installed and activated on the supplier computer 201. The functionality of the software is that every time access to a file in the storage medium 207 is desired, it is detected whether access is wanted to co-operation files; this can e.g. be done via the last name of the file. In case of a co-operation file, a request is sent to the central file server 205 in order to detect whether a newer version of the co-operation file is stored on the central file server 205. In order to ensure that two co-operation files are not mixed up, the co-operation may be provided with a unique ID and the request for files is made on the basis of their unique ID. On the central file server 205 it is checked whether a newer version of the co-operation file is stored thereon, and a message is sent to the supplier computer 201 telling it whether or not a newer version is available on the file server. Finally, the supplier computer 201 notifies the supplier via a user interface. The entire comparison of the version takes place automatically when access to the co-operation file is sought, and it is hereby ensured that the supplier has always access to and is aware of the existence of newer versions of the co-operation file.

The investigation in 209 is transparent to the supplier the same way as virus check software is transparent to the user. If the supplier's version of the co-operation file is identical with the version on the central file server, and a new version of the co-operation file is not under construction, nothing happens. If a new version is under construction, the supplier might contact the company for further information as to whether the existing version is to be used or whether the supplier should wait for the version under construction. If a new version exists, the supplier will be asked to retrieve the file from the central file server 205.

The file server can contain co-operation files for several customers where the co-operation files may be categorized logically and via searching facilities the supplier will always find the newest version of the co-operation file possessed by the client.

In an embodiment the file server 205 is not connected to the internal system of the whereby unauthorized use of the internal system is prevented. Also the customer is not forced to open the internal computer system for file transfer.

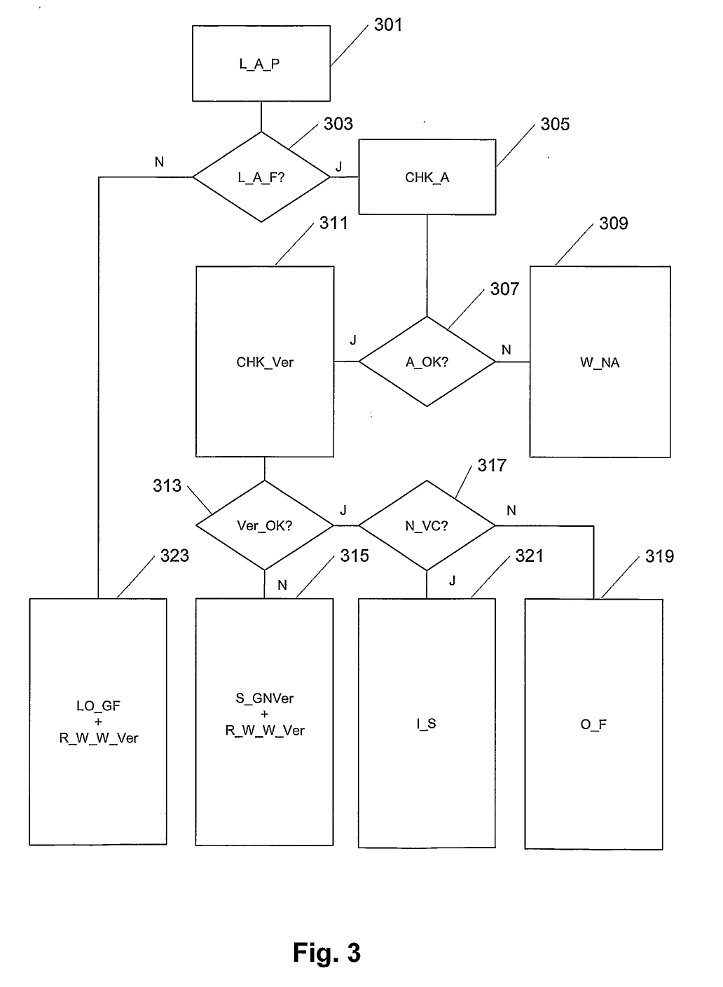

FIG. 3 shows a flow diagram of the functionality of the system when a supplier accesses a co-operation file. In 301 the procedure is activated in that the supplier wants to access a co-operation file (L_A_P). In 303 it is checked if the co-operation file is already stored on the supplier's storage medium (L_A_F). If this is not the case 323, connection to the central file server is established and the co-operation file with a unique ID is copied to the supplier's storage medium. In an embodiment it is registered who copies the co-operation file, when it is copied and which version is copied (LO_GF+R_W_W_Ver).

If the supplier already has the co-operation file, it is checked 305 if access to the central file server can be established (CHK_A). In 307 this is checked (A_OK) and if a connection is not possible 309, the supplier gets a warning via a user interface on the supplier computer that access cannot be established and thus that there is no guarantee that the co-operation file on the supplier's storage medium is the correct version (W_NA). If connection is established 311, it is checked whether the version of the co-operation file on the supplier's storage medium is identical with the version stored on the central file server (CHK_Ver). The investigation is done in 313 (Ver_OK). If it is not the same version 315, the supplier is urged to copy the newest version from the central file server using the user interface on the supplier computer. If the co-operation file is copied from the central file server, it is logged who copies the file, when it is copied and which version is copied (S_GNVer+R_W_W_Ver). If the same version is stored on both servers, it is in 317 checked if a new version of the co-operation file is under construction (N_VC). If this is the case, the supplier is urged, via a user interface on the supplier computer, to contact the customer as it may be better to wait until the new version is ready. If a new co-operation file is not under construction 319, the co-operation file on the supplier's storage medium is opened without further notice, and in one embodiment the supplier will not even notice that the investigations have taken place.

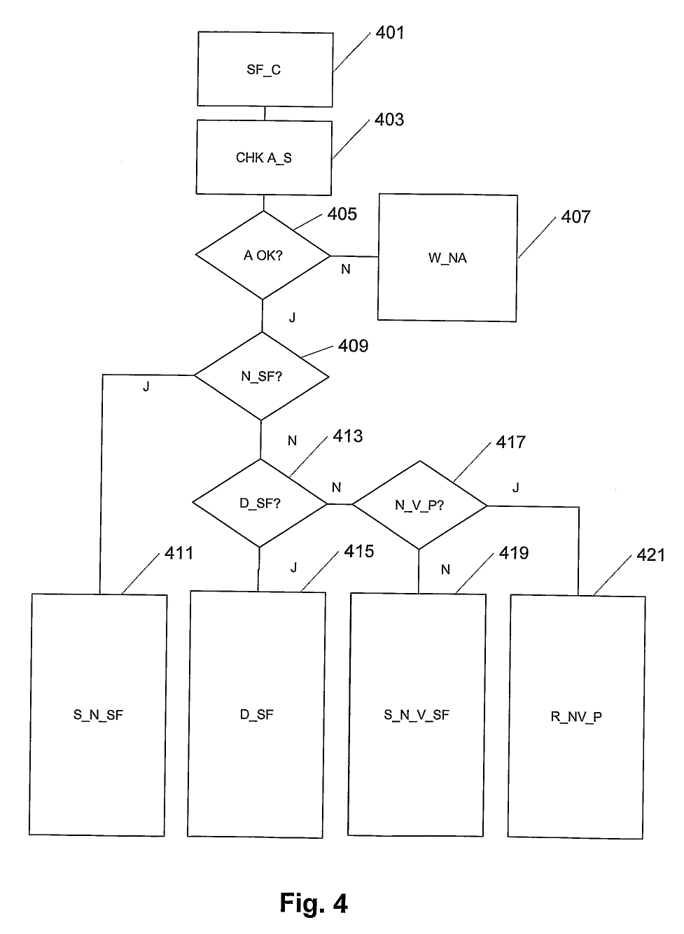

FIG. 4 shows a flow diagram of the functionality of the system, when a customer wants to change the co-operation file. In 401 the customer has created, changed or deleted a co-operation file stored on the customer's storage medium (SF_C). In 403 it is checked if a connection to a central file server with a file handling database can be established e.g. via the Internet (CHK A_S). In 405 the connection is checked (A_OK). If no connection can be established 407 the customer gets a warning that the co-operation file cannot be updated on the server. If a connection is established 409, it is checked in 409 if it is a new co-operation file (N_SF). If it is a new co-operation file 411, the customer copies the new file to the central file server. In an embodiment it is logged who copies the file and when it is done (S_N_SF). If it is not a new co-operation file it is in 413 checked if the co-operation file has been deleted (D_SF). If this is the case 415, the co-operation file on the central file server is marked as deleted (D_SF). It is further logged who has deleted the file and when it has been done.

If it is not because the co-operation file has been deleted, it is in 417 investigated if a new version of the co-operation file is under construction (N_V_P). If this is the case 421, the customer copies the co-operation file to the central file server and marks it as being under construction (R_NV_P). If the co-operation file is not under construction—but completed 419, the customer copies the new co-operation file to the central file server (S_N_V_SF). In both cases it is logged who copies the co-operation file to the central file server, when it is done and what it replaces.

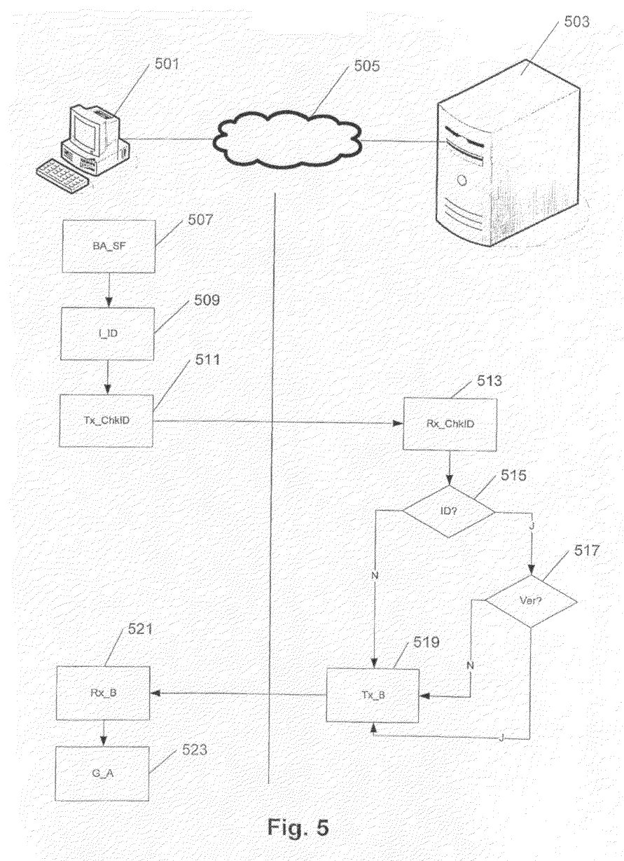

FIG. 5 shows a flow diagram illustrating the interaction between the supplier's computer 501 and the central file server 503 communicating via the Internet 505.

In 507 the user of the supplier computer 501 wants to access a co-operation file (BA_SF); whether or not a file is a co-operation file can e.g. be identified via the last name of the file. In 509 a unique ID (I_ID) for the co-operation file is identified and in 511 a request (Tx_ChkID) is transmitted to the central file server 503 along with the ID of the file.

In 513 the central file server 503 receives the request (Rx-Chk_ID) and in 515 it is checked if a file with the same ID is stored on the central file server 503. If this is not the case 519 a message (Tx_B) is sent to the user of the supplier computer 501. If a co-operation file with the same ID is stored on the central file server it is checked in 517 whether the co-operation file on the central file server 503 has been changed compared to the co-operation file on the supplier computer 501. If this is the case a message is sent 519 to the user of the supplier computer announcing this, and if this is not the case a message is sent 519 to the user of the supplier computer announcing this.

In 521 the supplier computer 501 receives the messages (Rx_B) from the central file server 503. The supplier computer then informs the user of the supplier computer and grants access 523 to the co-operation file (G_A).

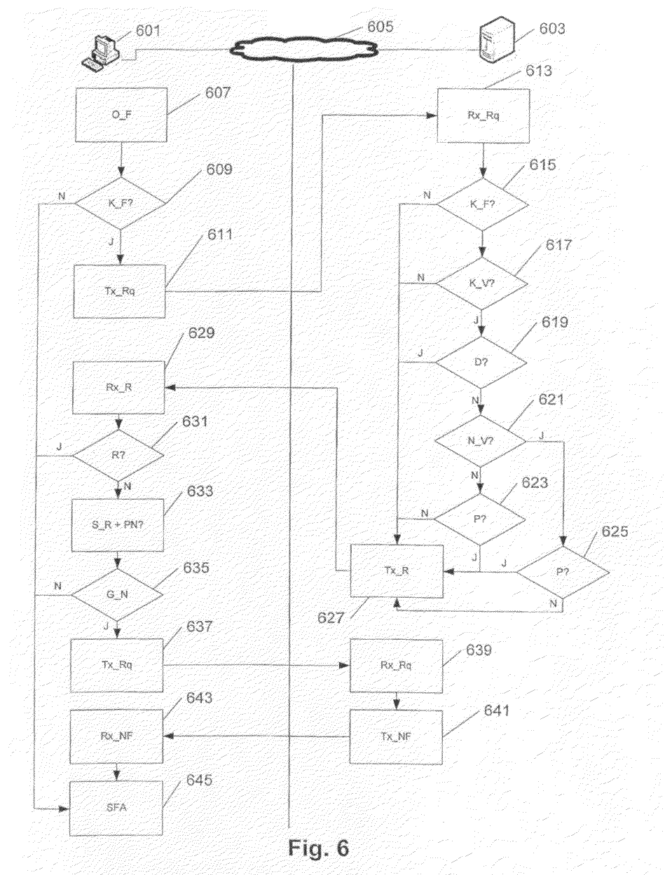

FIG. 6 shows a more detailed flow diagram illustrating by way of example the interaction between the supplier's computer 601 and the central file server 603 communicating via the Internet 605.

In 607 the user of the supplier computer 601 wants to access a file (O_F). In 609 it is investigated if the file is a co-operation file (K_F) of the type managed by the central file server. If this is not the case (N) the desired file can be accessed without further notice in 645 (SFA). If the file is a co-operation file (J) in 611 a request (Tx_Rq) is sent to the central file server 603.

In 613 the central file server 603 receives the request (Rx_rq) and in 615 it is checked whether it is a known file. If this is not the case (N) in 627 a message (Tx_R) is sent to the supplier computer that the co-operation file is not known to the central file server.

If the co-operation file is known (J) it is in 617 checked if the version number is known (K_V?). If this is not the case (N) a message is sent to the supplier computer indicating that the co-operation file has been corrected by the supplier himself and the supplier is given the possibility of downloading the newest file or alternatively marking the file ‘private’.

If the co-operation file version is known to the central file sever (J) it is in 619 investigated if the version is new (N_V?). If this is not the case (N) it is in 623 investigated if a new version is under construction (P?). If this is the case (J) in 627 a message is sent to the supplier computer telling that a new version is under construction. Furthermore, a notice containing contact information for the customer may be sent so that the supplier can contact the customer for the correct action. If a new version is not under construction (N) the supplier computer opens the co-operation file from the supplier storage medium in 645 (SFA).

If it is a new version (J) it is in 625 investigated if a file is under construction (P?). If this is the case (J) in 627 it is notified that a new version exists and it is offered that this version may be downloaded; furthermore it is notified that a revision is in progress. If a file is not under construction (N) it is in 627 notified that a new version exists and it is offered that this version may be downloaded.

In 629 the supplier computer 601 receives a message from the central file server 603. In 631 it is checked if the message notifies that the current version of the co-operation file on the supplier storage medium can be accessed (R?). If this is the case (J) the co-operation file is accessed in 645 (SFA). If this is not the case the message is in 633 shown to the supplier and the supplier should be asked if he wants to copy the new file (S_R+PN). This request (G_N) takes place in 635. If the supplier chooses not to copy the new file (N), the existing co-operation file is accessed in 645 (SFA). If the supplier chooses to access the new file, a request (Tx_Rq) is sent to the central file handling database 637. This message is received (Rx_Tq) in 639 where the central file handling database acknowledges the message by returning the new file (Tx_NF) in 641. The supplier computer receives the file (Rx_NF) in 643 and opens the file (SFA) in 645.

In the above it is described that the supplier retrieves the file form the central file server. In another embodiment, the supplier may access the file by online opening of the file placed on the central file server. What is important is that the supplier gets access to the newest version of the co-operation file.

1. A method for handling co-operation files, where the content of the co-operation files is of the type that describes the co-operation basis in relation to a co-operation between customers and suppliers, and where a unique ID is attached to a co-operation file, where the customer stores co-operation files on a central file handling database and where the co-operation files of the supplier are stored on a supplier computer, the method comprising:
checking if a co-operation file exists on the central database with an ID matching the ID of the co-operation file stored on the supplier's storage medium where the checking is initiated by the supplier trying to access the co-operation file stored on the supplier's storage medium,
informing the user of the supplier's computer if a version of the co-operation file stored on the central file server differs from the version of the co-operation file stored on the supplier's storage medium.

2. A method according to claim 1 where the user of the supplier computer is informed if a co-operation file having an ID corresponding to the ID associated with the co-operation file stored on the supplier computer does not exist on the central file server.

3. A method according to claim 1 where if a version differs, the amended co-operation file is transferred to the supplier computer.

4. A method according to claim 1 where the user of the supplier computer is informed if a new version of a co-operation file is under construction, and this information is obtained by using information attached to the co-operation file on the central file server.

5. A computer readable medium having stored therein instructions which make a processing unit perform the method according to claim 1.

6. A system for handling co-operation files where the content of the co-operation files is of the type that describes the co-operation basis in relation to a co-operation between customers and suppliers, and where a unique ID is associated with a co-operation file, where the customer stores co-operation files on a central file handling database and where the co-operation files of the supplier are stored on a supplier computer, the system comprising:
a processor adapted to check if a co-operation file exists on the central database with an ID matching the ID of the co-operation file stored on the supplier's storage medium where the check is initiated by the supplier trying to access the co-operation file stored on the supplier's storage medium,
a processor adapted to inform the user of the supplier's computer if a version of the co-operation file stored on the central file server differs from the version of the co-operation file stored on the supplier's storage medium.
